(19) United States
(12) Patent Application Publication
(10) Pub. No.: US 2004/0004602 A1
(43) Pub. Date: Jan. 8, 2004

(54) On-screen keyboard

(76) Inventors: Yung-Fa Cheng, Taipei (TW); Hsiang-Lung Kao, Taipei (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/301,101

(22) Filed: Nov. 21, 2002

(30) Foreign Application Priority Data
Jul. 5, 2002 (TW) 91210261

(51) Int. Cl. G09G 5/00

(52) U.S. Cl. 345/169

(57) ABSTRACT

An on-screen keyboard for a cellular phone. The on-screen keyboard includes a backlight module, a first transparent insulation film, a second transparent insulation film, a third transparent insulation film and a transparent film. The backlight module has a light-guiding plate and a light-emitting diode. The upper surface of the light-guiding plate is printed with numerals and figures. The first transparent insulation film is disposed on the backlight module. The upper surface of the first transparent insulation film is printed with transparent circuits. The second transparent insulation film is disposed on the first transparent insulation film and formed with multiple through holes. The third transparent insulation film is disposed on the second transparent insulation film. The lower surface of the third transparent insulation film is printed with multiple transparent conductive portions. The transparent film is disposed on the third transparent insulation film and has a picture thereon.

### BACKGROUND OF THE INVENTION

1. Field of the Invention

The present invention relates to an on-screen keyboard, and in particular to an improved on-screen keyboard for a cellular phone, providing the cellular phone with various configurations.

2. Description of the Related Art

FIG. 1 shows a conventional keyboard for a cellular phone 1. When using the cellular phone 1, to place a call, the user has to press keys 2. Similarly, the user has to press the keys 2 to perform other functions.

Nevertheless, the conventional keyboard fails to provide a pleasing appearance and restricts thickness reduction for the cellular phone 1.

Thus, the invention provides an improved on-screen keyboard for a cellular phone, providing the cellular phone with pleasing configurations and reducing the thickness thereof.

### SUMMARY OF THE INVENTION

An object of the invention is to provide an on-screen keyboard for a cellular phone. The on-screen keyboard comprises a backlight module, a first transparent insulation film, a second transparent insulation film, a third transparent insulation film and a transparent film. The backlight module has a light-guiding plate and a light-emitting diode. The light-emitting diode is disposed laterally to the light-guiding plate. The upper surface of the light-guiding plate is printed with numerals and figures while the lower surface is reflective. The first transparent insulation film is disposed on the backlight module. The upper surface of the first transparent insulation film is printed with transparent circuits. The second transparent insulation film is disposed on the first transparent insulation film and formed with multiple through holes. The third insulation transparent film is disposed on the second transparent insulation film. The lower surface of the third transparent insulation film is printed with multiple transparent conductive portions. The transparent conductive portions correspond to the through holes of the second transparent insulation film and the numerals and the figures on the upper surface of the light-guiding plate. The transparent film is disposed on the third transparent insulation film.

Preferably, the transparent film has a picture.

Preferably, the picture is drawn by pervious ink.

Preferably, the reflective surface of the light-guiding plate further comprises a plurality of reflective protrusions.

Preferably, the first transparent insulation film, the second transparent insulation film, the third transparent insulation film and the transparent film are a thin, strong polyester film such as MYLAR.

Preferably, the transparent circuits and the transparent conductive portions are indium-tin oxides (ITO).

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 shows a conventional keyboard for a cellular phone;

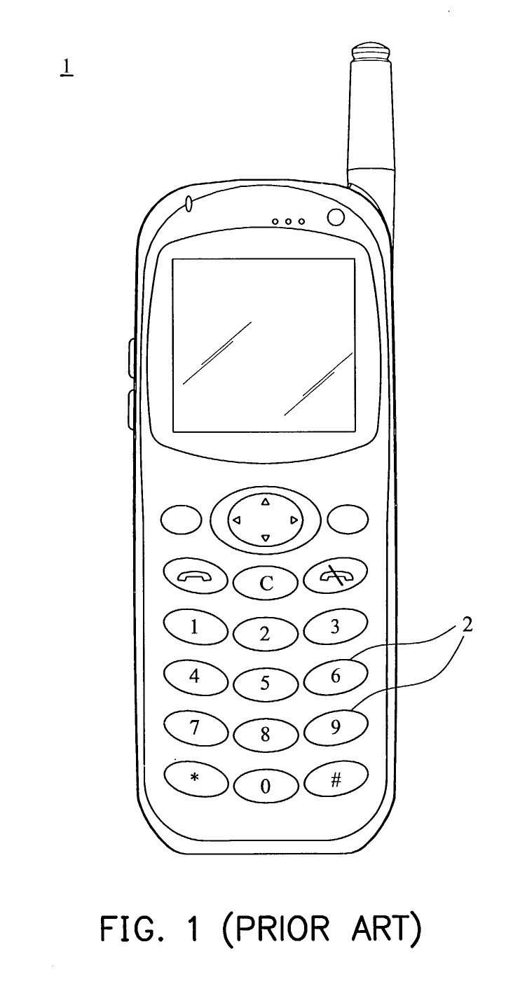

FIG. 2 is a perspective assembly view showing the on-screen keyboard of the invention;

FIG. 3 is a perspective exploded view according to FIG. 2;

FIG. 4 is a schematic view showing the present on-screen keyboard in stand by; and

FIG. 5 is a schematic view showing the present on-screen keyboard in use.

### DETAILED DESCRIPTION OF THE INVENTION

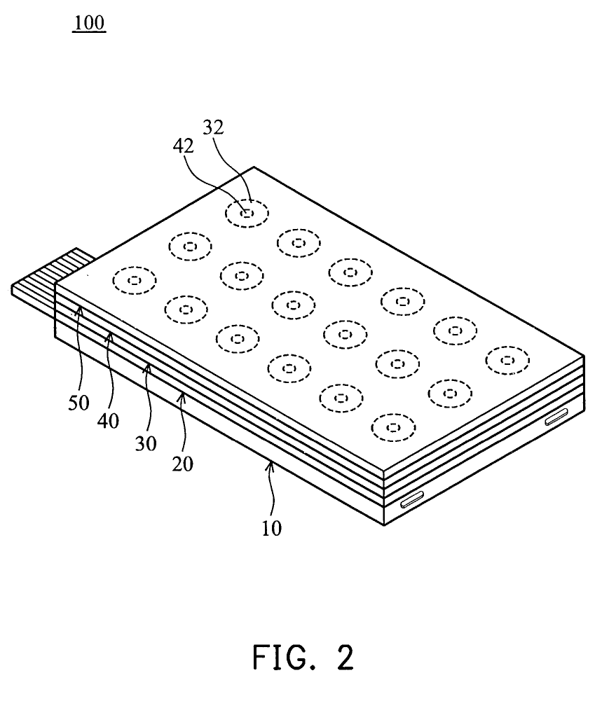

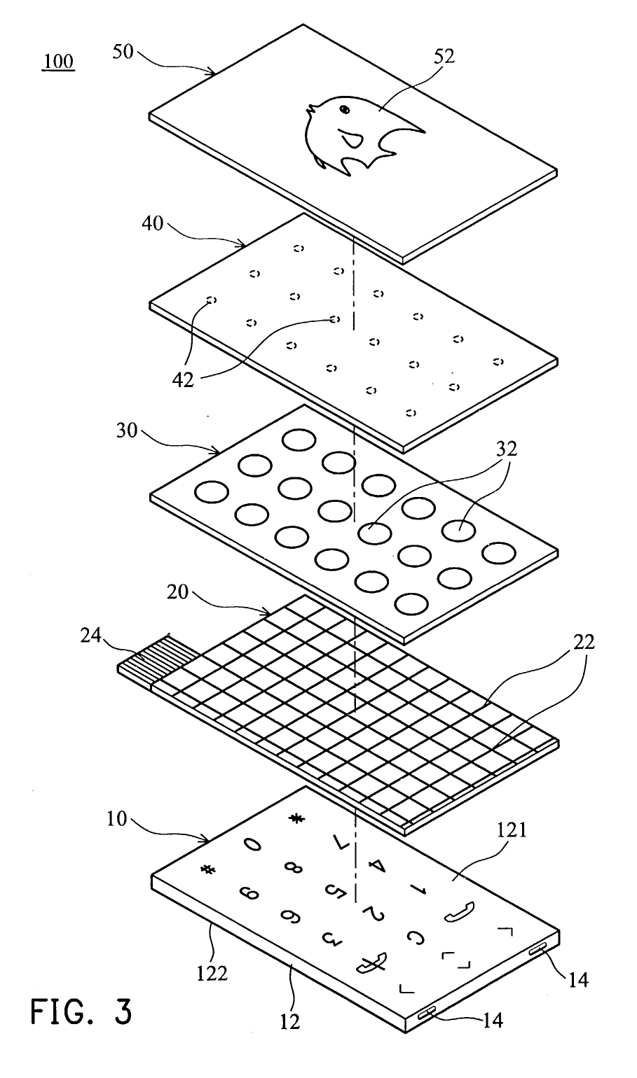

Referring to FIG. 2 and FIG. 3, the present on-screen keyboard 100 for a cellular phone comprises a backlight module 10, a first transparent insulation film 20, a second transparent insulation film 30, a third transparent insulation film 40 and a transparent film 50.

The backlight module 10 has a light-guiding plate 12 and two light-emitting diodes 14. The light-emitting diodes 14 are disposed laterally to the light-guiding plate 12 and serve as a backlight source. As shown in FIG. 3, the upper surface 121 of the light-guiding plate 12 is printed with numerals and figures while the lower surface 122 is an etched reflective surface (not shown). Specifically, the reflective surface of the light-guiding plate 12 is composed of a plurality of reflective protrusions (not shown). When light emitted from the light-emitting diodes 14 enters the light-guiding plate 12, the light is reflected upwardly by the etched reflective surface. Thus, the light from the light-emitting diodes 14 penetrates the light-guiding plate 12 via the upper surface 121.

The first transparent insulation film 20 is a thin, strong polyester film such as MYLAR and is disposed on the backlight module 10. The upper surface of the first transparent insulation film 20 is printed with transparent circuits 22. The transparent circuits 22 are laid on the first transparent insulation film 20 by an indium-tin oxide (ITO) having superior conductivity. In this embodiment, the transparent circuits 22 serve as key circuits of the on-screen keyboard 100. Additionally, a connecting portion 24 is disposed on one side of the first transparent insulation film 20. The transparent circuits 22 are electrically connected to a signal processing device (not shown) of the cellular phone via the connecting portion 24.

The second transparent insulation film 30 is a thin, strong polyester film such as MYLAR and is disposed on the first transparent insulation film 20. The thickness of the second transparent insulation film 30 is approximately 0.05 mm. Additionally, the second transparent insulation film 30 is formed with multiple through holes 32.

The third transparent insulation film 40 is a thin, strong polyester film such as MYLAR and is disposed on the second transparent insulation film 30. The thickness of the third transparent insulation film 40 is approximately 0.06 mm. The lower surface of the third transparent insulation film 40 is printed with multiple transparent conductive portions 42. The transparent conductive portions 42 correspond to the through holes 32. Thus, when the third transparent insulation film 40 is disposed on the second transparent insulation film 30, each transparent conductive portions 42 is located on the center of each through hole 32, as shown in FIG. 2. Also, the transparent conductive portions 42 correspond to the numerals and the figures of the light-guiding plate 12. In this embodiment, the transparent conductive portions 42 serve as keys of the on-screen keyboard 100. Similarly, the transparent conductive portions 42 are indium-tin oxides (ITO) having superior conductivity.

The transparent film 50 is disposed on the third transparent insulation film 40 and serve as the panel of the on-screen keyboard 100. The transparent film 50 can have any picture 52 drawn by pervious ink to enhance visual effect. Additionally, the transparent film 50, which can be replaced anytime, is a thin, strong polyester film such as MYLAR or plastic.

When the on-screen keyboard 100 is assembled, the second transparent insulation film 30 serves as a spacer to prevent the transparent conductive portions 42 of the third transparent insulation film 40 from touching the transparent circuits 22 of the first transparent insulation film 20.

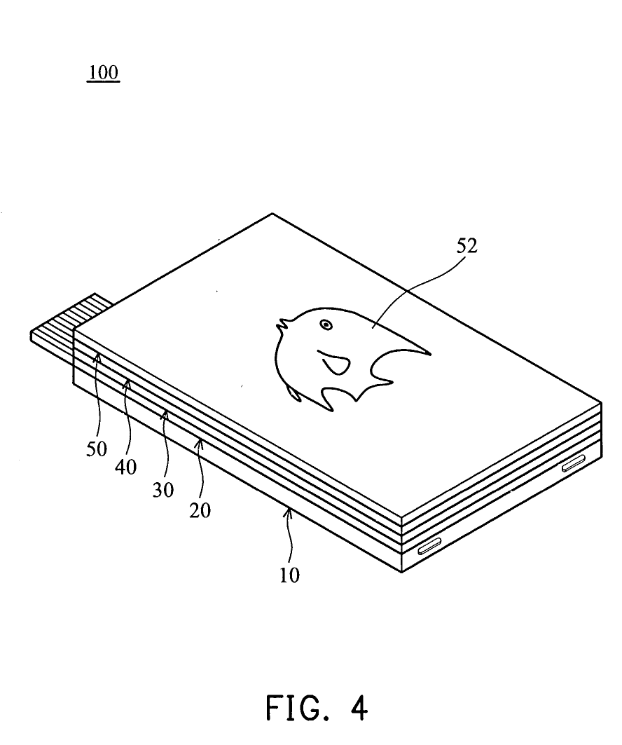

Referring to FIG. 4, when the cellular phone is in standby mode, only the picture 52 is displayed on the panel of the on-screen keyboard 100.

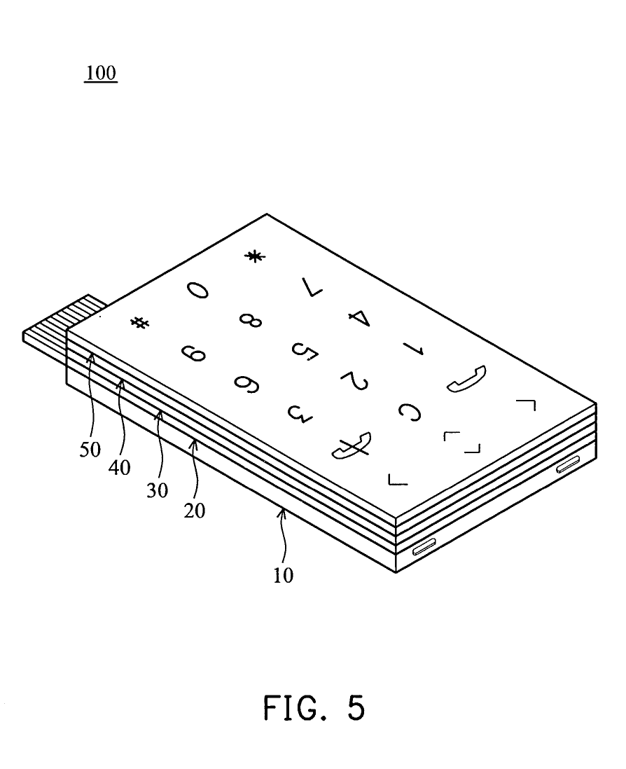

Referring to FIG. 5, when a user wants to operate the cellular phone or there is an incoming call, the backlight module 10 illuminates to penetrate the transparent film 50. Since the picture 52 on the transparent film 50 is rendered in pervious ink and the numerals and figures on the upper surface 121 of the light-guiding 12 are not penetrated by the light, the shadows of the numerals and figures are projected onto the transparent film 50. Thus, the panel of the on-screen keyboard 100 is displayed with the numerals and figures of the light-guiding 12 rather than the picture 52. At this time, the user can press the visible numerals and figures on the panel to make the transparent conductive portions 42 of the third transparent insulation film 40 contact the transparent circuits 22 of the first transparent insulation film 20. Then, a corresponding signal is output to the signal processing device for further processing.

In comparison with the conventional keyboard, the present on-screen keyboard 100 has many advantages as follows:

(1) The cellular phone can be decorative and visually appealing.

(2) The picture on the panel of the cellular phone can be changed at any time.

(3) The backlight of the on-screen keyboard illuminates the entire panel.

(4) The front appearance of the cellular phone having the present on-screen keyboard is different from that of a conventional cellular phone.

(5) The thickness of the cellular phone can be reduced.

While the invention has been described by way of example and in terms of the preferred embodiment, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An on-screen keyboard for a cellular phone, comprising:
a backlight module having a light-guiding plate and a light-emitting diode, the light-emitting diode disposed laterally to the light-guiding plate, wherein the upper surface of the light-guiding plate is printed with numerals and figures while the lower surface is reflective;
a first transparent insulation film disposed on the backlight module, wherein the upper surface of the first transparent insulation film is printed with transparent circuits;
a second transparent insulation film disposed on the first transparent insulation film and including a plurality of through parts;
a third transparent insulation film disposed on the second transparent insulation film, the lower surface of the third transparent insulation film printed with a plurality of transparent conductive portions, wherein the transparent conductive portions correspond to the through parts of the second transparent insulation film and the numerals and the figures on the upper surface of the light-guiding plate; and
a transparent film disposed on the third transparent insulation film.

2. The on-screen keyboard as claimed in claim 1, wherein the transparent film includes a picture.

3. The on-screen keyboard as claimed in claim 2, wherein the picture is rendered in pervious ink.

4. The on-screen keyboard as claimed in claim 1, wherein the reflective surface of the light-guiding plate further comprises a plurality of reflective protrusions.

5. The on-screen keyboard as claimed in claim 1, wherein the first transparent insulation film is a polyester film.

6. The on-screen keyboard as claimed in claim 1, wherein the second transparent insulation film is a polyester film.

7. The on-screen keyboard as claimed in claim 1, wherein the third transparent insulation film is a polyester film.

8. The on-screen keyboard as claimed in claim 1, wherein the transparent film is a polyester film.

9. The on-screen keyboard as claimed in claim 1, wherein the transparent circuits and the transparent conductive portions are indium-tin oxides (ITO).

10. An on-screen keyboard for a cellular phone, comprising:
a backlight module including a light-guiding plate and a light-emitting diode, the light-emitting diode disposed laterally to the light-guiding plate, and a first surface of the light-guiding plate printed with numerals and figures and a second surface of the light-guiding plate is reflective;
a printed transparent film disposed on the backlight module, the printed transparent film printed with transparent circuits; and
a corresponding transparent film disposed on the printed transparent film, the corresponding transparent film printed with a plurality of transparent conductive portions, wherein the transparent conductive portions correspond to the numerals and the figures on the first surface of the light-guiding plate.

11. The on-screen keyboard as claimed in claim 10, wherein the second surface of the light-guiding plate further comprises a plurality of reflective protrusions.

12. The on-screen keyboard as claimed in claim 10, wherein the printed transparent film is a polyester film.

13. The on-screen keyboard as claimed in claim 1, wherein the corresponding transparent film is a polyester film.

14. The on-screen keyboard as claimed in claim 1, wherein the transparent circuits and the transparent conductive portions are indium-tin oxides (ITO).
